(19) United States
(12) Patent Application Publication
(10) Pub. No.: US 2025/0012916 A1
(43) Pub. Date: Jan. 9, 2025

(54) PHASE DIFFERENCE CORRECTION METHOD AND ULTRA-WIDEBAND SYSTEM

(71) Applicant: Juri SIDORENKO, Ettlingen (DE)

(72) Inventor: Juri SIDORENKO, Ettlingen (DE)

(21) Appl. No.: 18/889,656

(22) Filed: Sep. 19, 2024

Related U.S. Application Data
(63) Continuation of application No. PCT/EP2023/057360, filed on Mar. 22, 2023.

(30) Foreign Application Priority Data
Mar. 23, 2022 (DE) 10 2022 202 846.5

(51) Int. Cl. G01S 13/84; G01S 13/02; G01S 13/36; G01S 13/58

(52) U.S. Cl. CPC G01S 13/84; G01S 13/0209; G01S 13/36; G01S 13/58

(57) ABSTRACT

A phase difference correction method for correcting a phase drift and/or phase offset is described, having: emitting a first signal by a first transceiver, receiving the first signal by a second transceiver, determining a first phase difference in the second transceiver between a first internal signal of the second transceiver and the received first signal, emitting a second signal by the second transceiver after expiry of a defined first delay time window, wherein the second signal comprises information on the determined first phase difference and/or information for determining the first phase difference, receiving the second signal by the first transceiver, determining a second phase difference in the first transceiver between a second internal signal of the first transceiver and the received second signal, and summing the first and the second determined phase differences, thereby correcting a phase offset between the two transceivers.

### CROSS-REFERENCE TO RELATED APPLICATIONS

This application is a continuation of copending International Application No. PCT/EP2023/057360, file Mar. 22, 2023, which is incorporated herein by reference in its entirety, and additionally claims priority from German Application No. 10 2022 202 846.5, filed Mar. 23, 2022, which is also incorporated herein by reference in its entirety.

### TECHNICAL FIELD

The present invention relates to a phase difference correction method and to an ultra-wideband system suitable for executing the phase difference correction method, as well as to a corresponding computer program code. In particular, a method for phase difference drift and offset correction suitable for ultra-wideband (UWB) localization is disclosed.

### BACKGROUND OF THE INVENTION

Information on a phase of a carrier wave are often used in navigation to improve or provide distance information. In satellite navigation, the measurement of the phase of the carrier wave is used in combination with the pseudo distance. The same principle can also be used for UWB localization systems, provided it is taken into account that the clocks used to generate the transmitted wave are inaccurate and therefore require drift and offset correction. The general approach to overcoming this problem is using wired connections between stations to distribute the clock signal. As a result, the phase drift is the same for each station. In [2], it is shown how the phase difference between two receive stations sharing the same clock signal can be obtained. This procedure can also be inverted by using two transmit stations [3]. In both cases, it is possible to use only one station instead of two. However, if only one station is used, several antennas must be present in the station.

Phase measurement according to any of the known methods just described is only applicable to systems where the clock signal is shared or where a station or transceiver has several antennas available for transmitting or receiving the signal.

FIG. 1 schematically shows an ultra-wideband system 100′, which is suitable for TOA measurement technology. A first transceiver 10′ transmits a first signal 21′, which is received by a second transceiver 20′. For this purpose, the first and second transceivers 10′, 20′ each comprise a transmitter and a receiver. The first transceiver 10′ and the second transceiver 20′ may be configured to create time stamps of the received and transmitted first and second signals 21′, 22′ and to transmit or receive these. A time stamp difference dT in combination with the known propagation speed c0 (speed of light) makes it possible to determine an unknown distance 25′ using d=c0 * dT. In practice, the first transceiver 10′ and the second transceiver 20′ are not synchronized. To solve this problem, a technique called two-way ranging can be used. To implement two-way ranging, the second transceiver 20′ responds to the first transceiver 10′ by transmitting the second signal 22′. The second signal 22′ contains information on the processing time between the received and the returned transmission time. This method will be explained in more detail in [4]. In addition to the clock error, UWB measurements are also subject to other interfering factors such as signal strength dependencies [5] or warm-up errors [6]. In this respect, the method described so far in FIG. 1 is known technology.

With regard to the described known method, it is to be noted that even with all the correction methods used, it is not possible for the timestamp-based position estimation to obtain a better position estimate than several centimeters.

It is an object of the present invention to provide an improved phase difference correction method and, thus, an improved ultra-wideband system, in particular without using several antennas or without having to share a clock signal of a crystal clock. It is an object to provide a method and an ultra-wideband system for improved ultra-wideband (UWB) localization, with which a position estimate has an accuracy of less than 5 cm.

### SUMMARY

According to an embodiment, a phase difference correction method for correcting a phase drift and/or phase offset may have the steps of: emitting a first signal by a first transceiver, receiving the first signal by a second transceiver, determining a first phase difference in the second transceiver between a first internal signal of the second transceiver and the received first signal, emitting a second signal by the second transceiver after expiry of a defined first delay time window, the second signal comprising information on the determined first phase difference and/or information for determining the first phase difference, receiving the second signal by the first transceiver, determining a second phase difference in the first transceiver between a second internal signal of the first transceiver and the received second signal, and summing the first determined phase difference and the second determined phase difference, wherein a phase offset between the two transceivers is corrected by this.

Another embodiment may have an ultra-wideband system having: a first transceiver and a second transceiver each configured to transmit and receive signals and spaced apart from each other, the system being configured to perform the phase difference correction method according to the invention as mentioned above.

According to an embodiment, a phase difference correction method for correcting a phase drift and/or phase offset may have the steps of: emitting a first signal by a first transceiver, receiving the first signal by a second transceiver and a third transceiver, determining a first phase difference in the second transceiver between a first internal signal of the second transceiver and the received first signal, determining a second phase difference in the third transceiver between a second internal signal of the third transceiver and the received first signal, emitting a second signal by the second transceiver after expiry of a defined first delay time window, receiving the second signal by the third transceiver, determining a third phase difference in the third transceiver between the second internal signal of the third transceiver and the received second signal, emitting a third signal by the second transceiver after expiry of a defined second delay time window by the second transceiver, in particular wherein the second signal and/or the third signal comprise information to the determined first phase difference and/or information for determining the first phase difference; receiving the third signal by the third transceiver; determining a fourth phase difference in the third transceiver between the second internal signal of the third transceiver and the received third signal, and finally determining a corrected phase difference according to:

$$dPcc = dP 2 - dP 3 - dP 1 - ( dP 3 - dP 4 ) .$$

Another embodiment may have an ultra-wideband system comprising: a first transceiver and a second transceiver and a third transceiver spaced apart from one another by a distance, the system being configured to perform the phase difference correction method for correcting a phase drift and/or phase offset according to the invention as mentioned above.

Another embodiment may have a non-transitory digital storage medium having stored thereon a computer program code for performing the phase difference correction method or the phase difference correction method for correcting a phase drift and/or phase offset according to the invention as mentioned above when the computer program code is executed on a program code executable medium.

With the phase difference correction method proposed herein and the further phase correction method, a position accuracy of less than 1 cm, in particular 0.8 mm, can be determined at a frequency of 6.5 GHZ, for example. At higher frequencies, position determination becomes even more accurate as the wavelength becomes smaller.

The core of the present invention is determining correction terms in order to correct a phase offset and/or a phase drift from the signals, in particular measured signals. In particular, the further phase correction method may include passive transceivers to perform the further phase correction method.

According to the suggestion, the phase difference correction method for correcting a phase drift and/or phase offset comprises first emitting a first signal by a first transceiver and receiving the first signal by a second transceiver. The suggested phase difference correction method can be carried out using time of arrival (TOA) measurement technology. After receiving the first signal, determining a first phase difference between a first internal signal, i.e. an internal wave, of the second transceiver and the received first signal follows. Determining the first phase difference takes place in the second transceiver. The phase difference is determined in that transceiver which receives a signal. Calculating corrections may take place in any transceiver. In any case, the phase difference correction method further comprises emitting a second signal by the second transceiver after expiry of a defined first delay time window, wherein the second signal comprises information on the already determined first phase difference and/or for determining the first phase difference. Determining the phase difference comprises measuring signals, i.e. receiving signals by a corresponding transceiver. Furthermore, determining the phase difference comprises evaluating the measured signals by calculating the phase difference. Calculating the phase difference can be performed by any transceiver or by a server or the like. In the phase difference correction method according to the invention, it is therefore conceivable for the first phase difference to be determined in the second transceiver. In this case, the second signal, which is transmitted from the second transceiver to the first transceiver, may comprise information on the already determined first phase difference. In the phase difference correction method according to the invention, it is also conceivable for the first phase difference to be determined in the first transceiver. In this case, the second signal, which is transmitted from the second transceiver to the first transceiver, may comprise at least one piece of information which enables the first transceiver to determine the first phase difference. Preferably, the second signal then comprises information on the first signal and the internal signal of the second transceiver. Furthermore, it is conceivable for the first phase difference to be determined in the first transceiver and in the second transceiver. This can reduce an error in the first phase difference. In this case, the second signal, which is transmitted from the second transceiver to the first transceiver, may comprise at least one piece of information which enables the first transceiver to determine the first phase difference and the information on the first phase difference already determined in the second transceiver.

In each of the cases, the second signal comprises a signal for determining a second phase difference in the first transceiver. In other words, a signal for determining a phase difference comprises the measured signals from which the phase difference in any transceiver or from a server or in a cloud can be calculated. The phase difference correction method comprises receiving the second signal by the first transceiver. After receiving the second signal by the first transceiver, determining the second phase difference in the first transceiver between a second internal signal of the first transceiver and the received second signal takes place. Finally, summing of the first determined phase difference and the second determined phase difference takes place, wherein a phase offset between the two transceivers is corrected by this. If there were no drift, the phase difference obtained in this way would only depend on the distance between the first and second transceivers and would therefore correspond to a signal phase. The first phase difference is advantageously determined in the second transceiver. The measurements used for this are executed in the second transceiver. For example, the first signal 21 is measured in the second transceiver 20 and the second and third signals 22, 23 are measured in the first transceiver 10. Together, the corrected phase difference, i.e. the signal phase, can be calculated by means of the measured signals 21, 22, 23. Where the calculation takes place is irrelevant; it can therefore be calculated in the first and/or second transceivers. It is only important that the measured signals 21, 22, 23 are available for calculating the corrected phase difference when calculating the corrected phase difference is carried out.

A transceiver comprises at least one antenna for receiving signals. A phase value of a received signal is determined by obtaining a phase of a signal as a function of a complex baseband impulse response of the transmit signal received by the antenna. When a signal is received by a transceiver, the SFD (start frame delimiter), the real part of the signal and the imaginary part of the signal are measured. These measured values can then be used to calculate the phase difference between the received signal and an internal signal.

Some terms used in this application are explained below in order to define the terms in the context of this application.

In the present application, a signal is to be understood to be an electromagnetic wave, in particular with or without modulated information. The term signal can be replaced by the term wave, since wave and signal are used synonymously. In the present case, the signals are transmitted and received as digital signals. Of course, an analog signal can also be transcribed into a digital signal. In the present case, the signals are transmitted between transceivers, wherein in the present case a transceiver may comprise only a receiver, provided that the receiver is sufficient for executing the phase difference correction method according to the invention. When a receiver is sufficient, will be explained to the person skilled in the art by the further description. Usually, a transceiver comprises a transmitter and a receiver.

The term “internal wave” or “internal signal” can be explained as follows: A quartz oscillator clock (crystal clock) drives a PLL (Phase Locked Loop), which generates a carrier wave. This carrier wave is not only used for transmission, but also to demodulate the received signal. A downconverter mixer is used here. If a signal is received by an antenna, the downconverter mixer determines the I/Q data with the internal signal.

These provide information on the phase difference ¢ between the internal signal and the received signal according to

$$Φ = arctan ( \frac{Q}{I} ) .$$

After digitalizing the I/Q data by the analog-to-digital converter (ADC), the baseband processor can form the pulse response to associate the I/Q data to the direct signal.

The term phase difference refers to the difference between the phase of the received signal and the phase of the internal wave of the quartz clock. This is determined by reading out the I/Q data in the impulse response (Channel Impulse Response). Specific to the UWB chip, this data are to be further accounted to determine the phase difference, for example with the drift synchronization frame delimiter (SFD). When the present application refers to determining the phase difference, this means determining all data used for calculating the phase difference, in particular SFD, real part and imaginary part of the received signal, which are generated when the message is received. It is irrelevant where these data are combined to form the actual phase difference. In other words, the phase difference as such can be calculated by any transceiver.

According to the technical teaching described herein, several phase differences are formed between the transceivers in order to determine the signal phase, which is dependent only on the distance between two transceivers. The drift and offset corrected phase difference will be referred to as signal phase dPc for TOA or dPcc for TDOA.

Preferably, the phase difference correction method is executed in a sequence of the individual steps as claimed in claim 1 one after the other. However, it is conceivable for a determination of the first and second phase differences to be performed only after the first signal and the second signal have been exchanged between the first transceiver and the second transceiver.

Another aspect of the present invention comprises an ultra-wideband system having a first transceiver and a second transceiver, each configured to transmit and receive signals and spaced apart from each other, wherein the system is configured to perform a phase difference correction method as described herein. By performing the phase difference correction method, a phase offset between the two transceivers is corrected, wherein the phase difference is a function of the distance between the two transceivers. After correcting the phase difference, the signal phase is thus obtained. The ultra-wideband (UWB) system according to the invention has transmit, receive or transmit/receive stations, called transceivers in the present case. The receive stations, i.e. the transceivers, can obtain the phase difference between the carrier wave, i.e. the first signal, and/or the second signal and/or a third signal. The internal wave or signal used to determine a phase difference is independent of which signal is transmitted and/or received. The internal wave has a frequency with a certain accuracy and a phase drift

Using the presented correction method, the corrected phase difference, i.e. the signal phase, can be realized in the case of distributed UWB stations with clock inaccuracy.

A further aspect of the present invention comprises a further phase difference correction method, in particular for passive transceivers, for correcting a phase drift and/or a phase offset. Passive transceivers comprise a receiver for receiving signals. The further phase difference correction method initially comprises emitting a first signal by a first transceiver and receiving the first signal by a second transceiver and a third transceiver. Compared to the phase difference correction method described above, in the further phase difference correction method, the first signal is transmitted to and received by two different transceivers, the second and third transceivers. The first to third transceivers can be spaced apart from one another. It is also conceivable for the second transceiver and the third transceiver to be realized in one transceiver. After receiving the first signal by a second transceiver and a third transceiver, the further phase difference correction method comprises determining a first phase difference in the second transceiver and determining a second phase difference in the third transceiver. The first phase difference is determined between a first internal signal of the second transceiver and the received first signal. The second phase difference is determined between a second internal signal of the third transceiver and the received first signal. Furthermore, the further phase difference correction method comprises emitting a second signal by the second transceiver after expiry of a defined first delay time window. This step is performed in analogy to the phase difference correction method already described. After receiving the second signal by the third transceiver, a third phase difference is determined in the third transceiver between the second internal signal of the third transceiver and the received second signal.

Furthermore, the additional phase difference correction method comprises emitting a third signal by the second transceiver. In particular, the third signal is emitted by the second transceiver after expiry of a defined second delay time window. Furthermore, the second signal and/or the third signal may comprise information on the determined first phase difference and/or for determining the first phase difference. The explanations which have already been made with regard to the phase difference correction method also apply to the further phase difference correction method and will not be repeated here. In addition, the further phase difference correction method comprises receiving the third signal by the third transceiver. After receiving the third signal by the third transceiver, a fourth phase difference is determined in the third transceiver. The fourth phase difference is determined between the second signal received by the third transceiver and the second internal signal. Finally, a corrected phase difference is determined by subtracting the first and twice the third determined phase differences from the sum of the determined second and fourth phase differences according to:

$$dPcc = dP 2 - dP 3 - dP 1 - ( dP 3 - dP 4 ) = d P 2 + dP 4 - 2 * dP 3 - dP 1.$$

The second phase difference dP2 is the phase difference between the first received signal and the second internal signal of the third transceiver. The difference between the third and the fourth phase difference (dP3−dP4) indicates the drift correction and the first phase difference dP1 indicates the offset correction. The term dPcc can be determined using the time of arrival difference measurement technique.

Ideally, the corrected phase difference is zero, i.e. after correcting the phase difference, there is no longer a phase difference, but the signal phase.

Some steps of the further phase difference correction method are analogous to the steps of the phase difference correction method. Consequently, the further detailed descriptions of the further phase difference correction method are transferable to the further phase difference correction method. Further detailed descriptions of individual features are omitted to avoid redundancies. However, it is to be understood that features described in relation to the phase correction method can also be transferred in analogy to the further phase correction method and vice versa, provided an analogous transfer is not explicitly excluded.

Another aspect of the present invention comprises an ultra-wideband system having a first transceiver and a second transceiver and a third transceiver spaced a distance apart from one another, the system being configured for a phase difference correction method as described. By performing the phase difference correction method, a phase offset between the two transceivers is corrected. The ultra-wideband (UWB) system according to the invention has transmit, receive or transmit/receive stations, called transceivers in the present case. The receive stations, i.e. the transceivers, can obtain the phase difference between the carrier wave, i.e. the first signal and/or the second signal and/or a third signal, and the internal wave, i.e. the first internal signal and/or the second internal signal and/or a third internal signal. Using the presented correction method, the phase difference can be realized in the case of distributed UWB stations with clock inaccuracies.

Another aspect of the present invention comprises computer program code performing steps of a phase difference correction method as described herein when the computer program code is executed on a program code executable medium.

Essentially, the correction method comprises correcting the phase drift and/or the phase offset. This can be implemented between two active stations or active transceivers (transmit and receive signals) or any number of passive transceivers (receive only). A passive transceiver corresponds to a receiver.

The technical teaching described herein discloses how the phase difference between two or more transceivers, in particular UWB transceivers, can be corrected without having to split the clock signal and/or without having to use special antenna arrays. By correcting the phase difference, the signal phase can be obtained, which is only a function of the distance between the transceivers.

The phase difference correction method and the further phase correction method disclosed herein could be verified by real measurements. Based on the real measurements, it could be shown, for example, that the corrected phase difference, i.e. the signal phase, can be used to significantly increase the precision and accuracy of UWB localization systems, as can be seen from the image description below.

In the known technology, it has previously only been known that a position determination in the UWB range could only be determined with an accuracy of several cm. Using the invention disclosed herein, however, a position is detected with an accuracy of 0.8 mm at a frequency of 6.5 GHZ. At higher frequencies, position determination becomes even more accurate as the wavelength becomes smaller.

This is a technical improvement over the known technology. For a phase measurement according to any of the methods described in the introduction is only applicable to systems in which the clock signal is shared or in which a station has several antennas which are available for transmitting or receiving the signal. The phase difference correction method or the further phase difference correction method according to the invention not only makes it possible to solve this problem, but the phase difference correction method or the further phase difference correction method can also be used for time of arrival (TOA) or time difference of arrival (TDOA). Active and/or passive transceivers can also be used.

The technical teaching disclosed here is of advantage in areas where high positioning accuracy plays an important role, such as augmented reality, robotics, military, etc.

Additionally, the meaning of the abbreviations used in this document is also explained here:

TOA: Time of arrival measurement technology (TOA=Time of Arrival)

TDOA: Time Difference of Arrival measurement technique (TDOA=Time Difference of Arrival)

### BRIEF DESCRIPTION OF THE DRAWINGS

The drawings are not necessarily to scale; rather, emphasis is generally placed on illustrating the principles of the invention. In the following description, various embodiments of the invention are described referring to the following drawings, in which:

FIG. 1 schematically shows an ultra-wideband system with a TOA between two UWB transceivers;

FIG. 2 schematically shows a flow of a phase difference correction method according to the invention in an ultra-wideband system;

FIG. 3 shows phase difference correction for TOA;

FIG. 4 shows a phase difference dP1 between two transceivers without corrections;

FIG. 5 shows a sum of the phase difference dP1 and dP2;

FIG. 6 shows a final corrected TOA signal phase obtained according to the invention;

FIG. 7 shows a changed signal phase due to TOA distance changes;

FIG. 8 shows the calculated distance based on the signal phase;

FIG. 9 shows a possible solution S based on four different frequencies F1-F4;

FIG. 10 shows results of the accuracy update due to frequency changes;

FIG. 11 schematically shows an ultra-wideband system with a TDOA between three UWB transceivers;

FIG. 12 schematically shows a flow of a further phase difference correction method according to the invention in an ultra-wideband system;

FIG. 13 shows a phase difference correction for TDOA obtained according to the invention;

FIG. 14 shows a changed phase due to TDOA position changes; and

FIG. 15 shows a sketch for explaining the term “internal signal”.

### DETAILED DESCRIPTION OF THE INVENTION

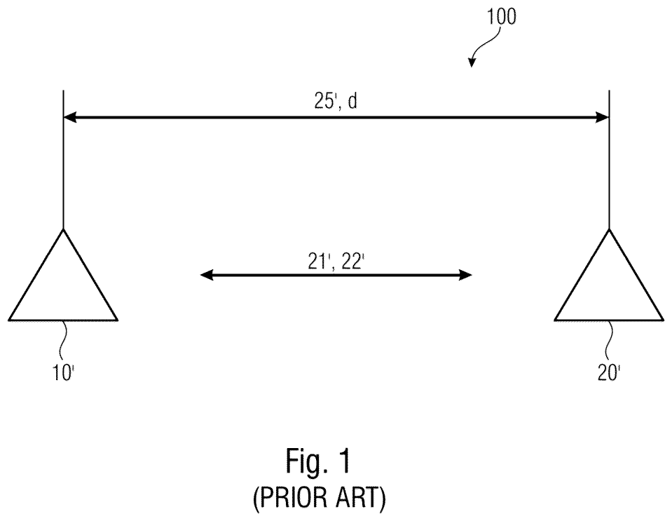

Equal or equivalent elements or elements with equal or equivalent functionality are referred to in the following description by equal or equivalent reference numbers, even if they appear in different figures. In the present case, for example, the term signal is used synonymously for electromagnetic wave and vice versa. The technical teaching described herein will be described below in connection with FIGS. 1 to 12.

In the following description, a large number of details are given in order to provide a continuous explanation of embodiments of the present invention. However, it will be apparent to those skilled in the art that embodiments of the present invention may be implemented without these specific details. In other cases, known structures and devices are illustrated in block diagrams or schematic diagrams rather than in detail to avoid obscuring embodiments of the present technical teaching. Furthermore, features of the various embodiments described below may be combined with one another, unless explicitly stated otherwise.

As mentioned in the introduction, phase measurement has previously only been applicable to systems in which the clock signal is shared or where a transceiver has several antennas available to transmit or receive the signal.

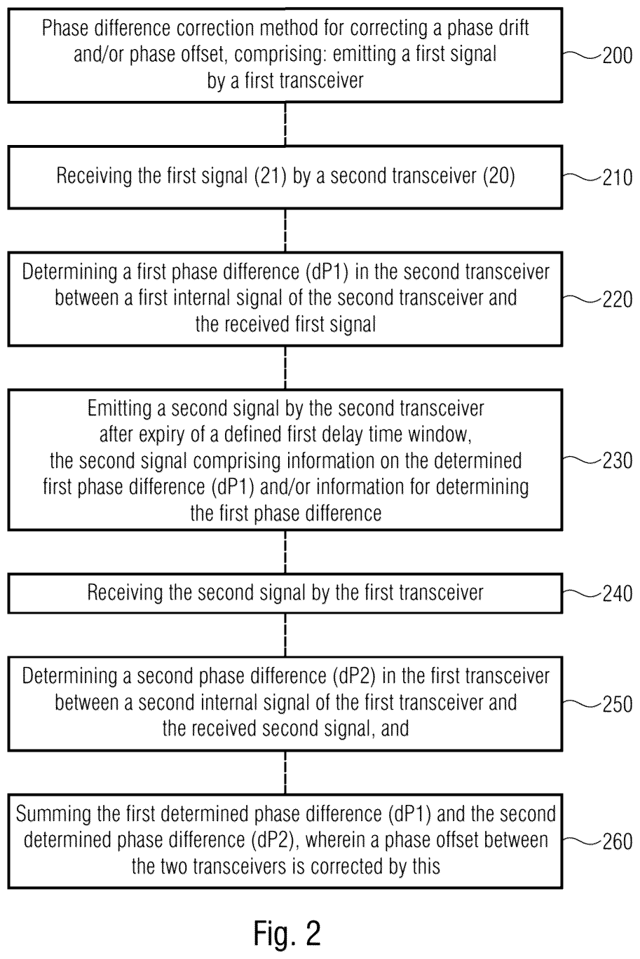

The phase difference correction methods according to the invention solve these problems and can be used both in a method in which the time of arrival (TOA) is relevant and in a method in which the time difference of arrival (TDOA) is relevant. This will be explained below referring to advantageous embodiments. Looking at FIGS. 2 to 10 and 12 to 14 together, the advantageous embodiments will discussed in detail.

The Phase Correction Method According to the Invention can be Used in Particular in Connection with the Time of Arrival (TOA):

With regard to the known method described in the introduction, it is again mentioned that even with all the correction methods used, it is not possible for the timestamp-based position estimation to obtain a better position estimate than several centimeters. This limitation can be overcome by using the phase difference correction method according to the invention.

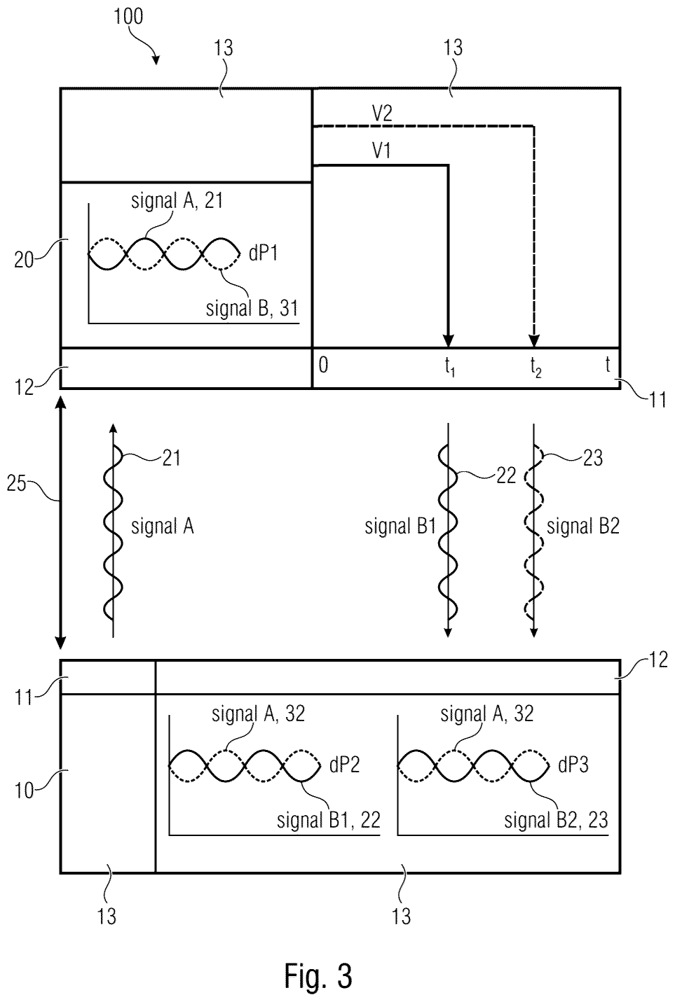

The phase difference correction method according to the invention for performing a phase difference correction with time of arrival measurements is shown in a flow diagram in FIG. 2 and schematically as a realization in an ultra-wideband system 100 in FIG. 3. FIGS. 2 and 3 are therefore described together.

In a first step 200 of the phase difference correction method for correcting a phase drift and/or a phase offset, a first signal 21 is emitted by a first transceiver 10. The first and second transceivers 10, 20 are spaced apart by a distance 25. In a subsequent step 210, the first signal 21 is received by a second transceiver 20. The first and second transceivers each comprise a transmitter 11 and a receiver 12. The first and second transceivers each comprise a control device 13 to process the transmitted and received signals 21, 22. As already disclosed in the general part of the description, the individual transceivers, i.e. the first and the second transceiver, are configured to measure measured values such as the SFD, the real part and the imaginary part of the received signal 21, 22, 23 when receiving a signal. From the measured values, i.e. the measured signals 21, 22, 23, the phase difference can then be calculated at any transceiver 10, 20, i.e. the first and/or the second transceiver 10, 20. The phase difference can also be calculated on a server. For this purpose, only the measured signals 21, 22, 23 have to be provided.

After receiving the first signal 21 by the second transceiver 20, a first phase difference dP1 in the second transceiver 20 between a first internal signal 31 of the second transceiver 20 and the received first signal 21 is determined in step 220.

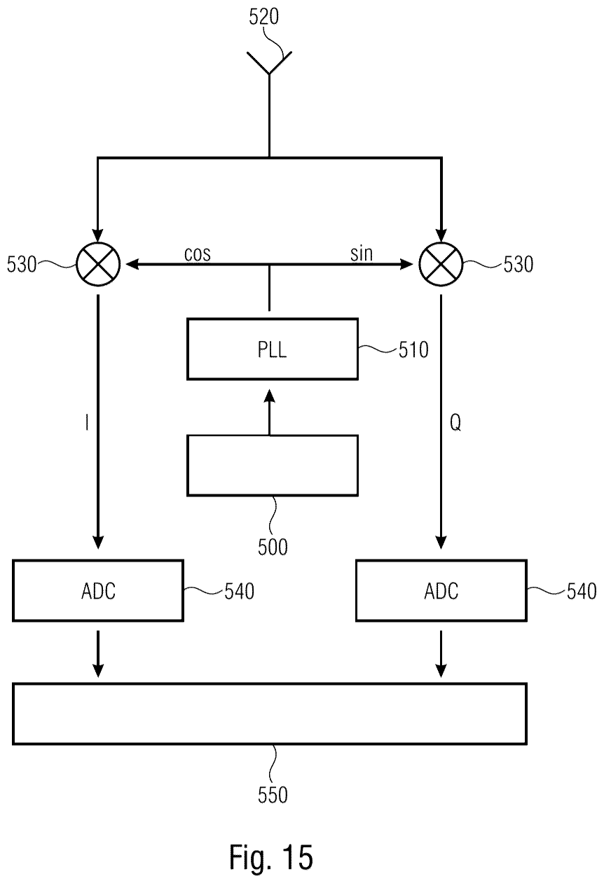

Reference is made to FIG. 15 for an explanation of the term “internal wave” or internal signal 31, 32. FIG. 15 schematically shows that a quartz oscillator clock (crystal clock) 500 drives a PLL 510 (phase locked loop) which generates a carrier wave. This carrier wave is not only used to transmit, but also to demodulate the received signal (see FIG. 15). A down converter mixer is used for this purpose. If a signal is received with an antenna 520, the downward mixer 530 determines the I/Q data. These provide information on the phase difference ¢ between the internal signal and the received signal according to Φ=arctan (Q/I). After the I/Q data have been digitized by the analog-to-digital converter (ADC) 540, the baseband processor 550 can form the impulse response to associate the I/Q data to the direct signal.

In step 230, a second signal 22 is emitted by the second transceiver 20 after expiry of a defined first delay time window V1, wherein the second signal 22 comprises information for the specific first phase difference dP1 and/or information for determining the first phase difference. Information for determining the first phase difference comprise those measured values which are used for calculating the phase difference. The calculated phase differences dP1, dP2, dP3 and other information can be accessible to all transceivers because all active transceivers can send and receive information and can therefore also pass it on to a passive transceiver. At this point it is to be noted that steps 220 and 230 can be one after the other, i.e. first step 220 then step 230. It is equally possible for step 230 to occur first and then step 220. In this case, the second signal comprises information for determining the first phase difference, which would then be determined in the first transceiver 10 and not in the second transceiver 20. The first delay time window V1 indicates a period of time from receiving the first signal 21 to emitting the second signal 22. The first delay time window V1 may comprise a period of time of a few milliseconds, in particular less than two milliseconds. The second transceiver 20 can send a response, i.e. the second signal 22, back to the first transceiver after a defined delay time V1, the first delay time window V1. The delay time window V1 is considered in relation to the period of time at which the first signal 21 is received.

In step 240, the second signal 22 is received by the first transceiver 10. The second signal 22 can be the first internal signal 31 including a possible drift. In FIG. 3, for example, the first internal signal 31 is shown as signal B, whereas the second signal 22 is shown as signal B1.

After the first transceiver 10 has received the second signal, a second phase difference dP2 is determined in the first transceiver 10 in step 250. The second phase difference dP2 is determined between a second internal signal 32 of the first transceiver 10 and the received second signal 22. The second internal signal 32 may, for example, correspond to the first signal 22, which is also referred to as signal A in FIG. 3. However, the second internal signal 32 may also be different from the first signal 21. Different in the sense that it is still the same second internal signal 32, but has a different phase in the first signal 21 due to the elapsed time window. In addition, the received first signal 21 may exhibit a phase drift which can be corrected with a third signal 23.

In subsequent step 260, the first determined phase difference dP1 and the second determined phase difference dP2 are summed, wherein a phase offset between the two transceivers is corrected by this. With reference to the disclosure of FIG. 3, it is to be noted that only a first signal 21, a second signal 22, a first internal signal 31 and a second internal signal 32 are used to correct a phase offset between the first and second signals 21, 22, i.e. between the two transceivers.

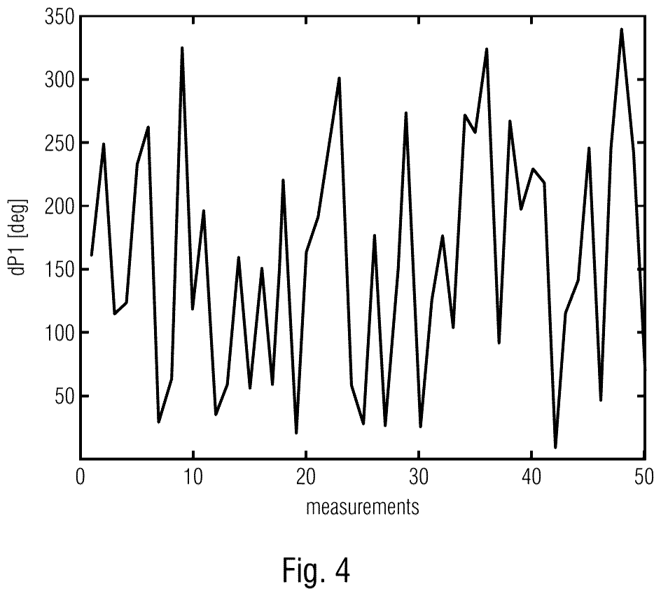

The phase difference dP1 is shown in FIG. 4. FIG. 4 shows the determined first phase difference as a function of the number of measurements. It can be observed that the phase difference dP1 changes rapidly from one measurement to the next.

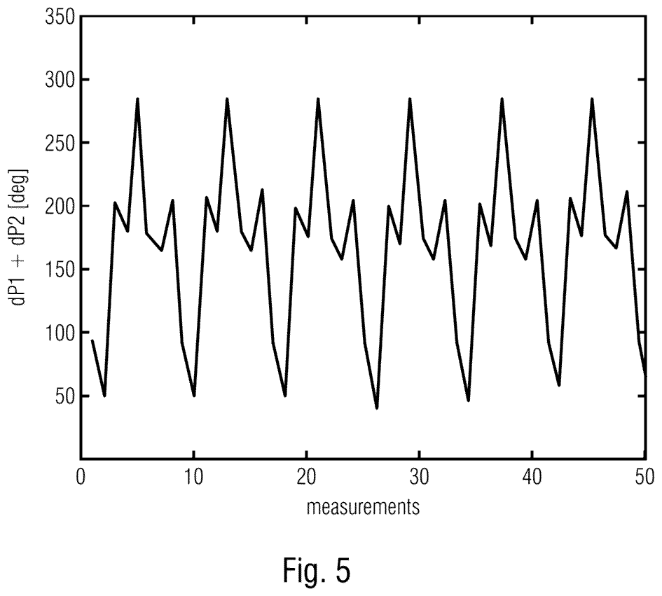

The first transceiver 10 serves as an initialization transceiver by emitting the first signal 21. Both the first transceiver 10 and the second transceiver 20 comprise the same method steps, namely determining a phase difference dP1, dP2 between the received signal 21, 22 and the internal signal 31, 32, cf. to FIG. 3. The sum of the first phase difference dP1 and the second phase difference dP2 reduces, in particular eliminates, the phase offset between the two transceivers 10, 20 as shown in FIG. 5. FIG. 5 shows the sum of the first phase difference dP1 and the second phase difference dP2 as a function of the number of measurements. A total of 50 measurements were carried out in both FIG. 4 and FIG. 5. In contrast to FIG. 4, FIG. 5 shows a periodic signal, i.e. the sum of dP1+dP2 is periodic, particularly within an apparent envelope. The apparent envelope occurs when one transceiver has a higher clock rate than the other transceiver. This means that one transceiver repeatedly overtakes the other transceiver.

If the second signal 22, also referred to as signal B1 in FIG. 3, were sent immediately after receiving the first signal 21, also referred to as signal A1 in FIG. 3, no further drift correction would be necessary, as described below. Immediately after receiving the first signal 21 here means after one millisecond or less.

However, short processing times can result in phase drift. Accordingly, after a known second delay time 2, a second delay window V2, a third signal 23 is transmitted by the second transceiver 20. The term “short processing time” depends on the drift of the involved signal at a signal frequency. Certainly, a short processing time can mean a processing time >1 ns.

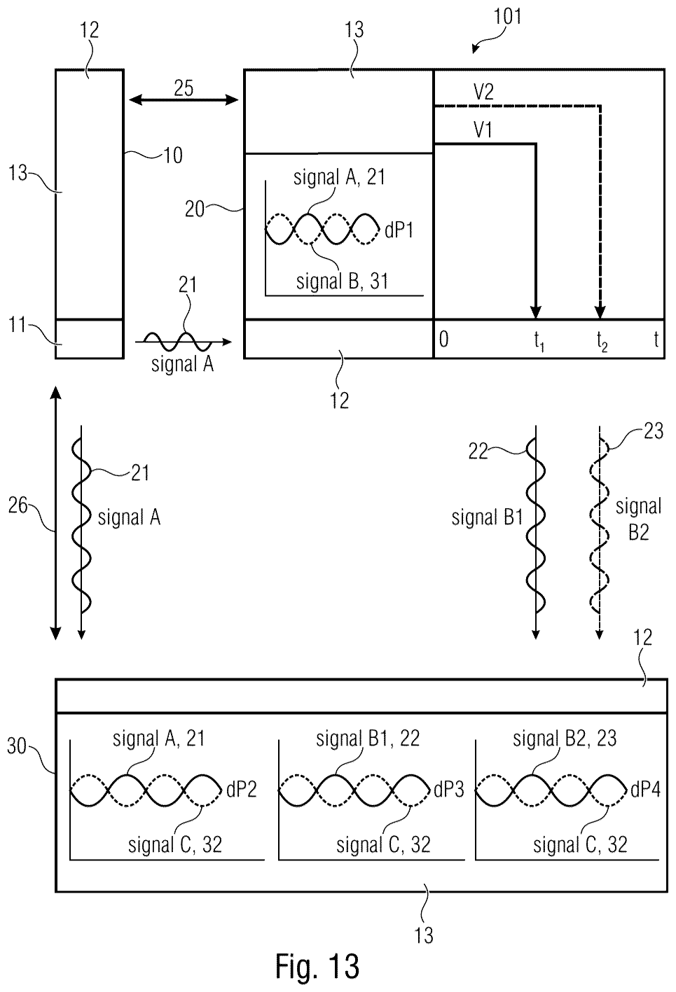

Preferably, a ratio between the second delay time window V2 and the first delay time window V1 is known, in particular and in the simplest case, if the same start time is assumed, V2=2*V1 (see FIGS. 3 and 13). It is assumed that the clock drift does not change significantly during receiving the first signal 21 until transmitting the second signal 22. Further, advantageously, the first delay time window V1 corresponds to a time interval between receiving the first signal 21 by the second transceiver 20 and emitting the second signal 22 by the second transceiver 20, in particular the first delay time window V1 is less than or equal to 1 ms. Further, advantageously, the second delay time window V2 corresponds to a time interval between receiving the first signal 21 by the second transceiver 20 and emitting the third signal 23 by the second transceiver 20, which is in particular less than or equal to 2 ms. Preferably, the following applies to the second delay time window V2:

V2=2*V1.

In this case, a phase drift can be corrected by means of a phase difference correction term, as explained below.

A phase drift of the second transceiver 20 with respect to the first transceiver 10 is obtained by the phase difference between the second signal 22, also referred to as signal B1 in FIG. 3, and a third signal 23, also referred to as signal B2 in FIG. 3, transmitted in particular by the second transceiver after expiry of the second time delay window V2. This results in a final TOA phase difference correction term: dPc=dP1+dP2+(dP2−dP3)=dP1+2*dP2−dP3, whereas dP3 is a third phase difference. The third phase difference dP3 is the difference between the internal wave in relation to the signal B2.

Consequently, the phase difference correction method advantageously comprises emitting the third signal 23 by the second transceiver 20 after expiry of the defined second delay time window V2. In particular, the third signal 23 comprises information on the second signal 22, such as the first phase difference dP1. Furthermore, the phase difference correction method advantageously comprises receiving the third signal 23 by the first transceiver 10 and determining the third phase difference dP3 between the third signal 23 received by the first transceiver 10 and the second internal signal 32. Here, the third phase difference dP3 determines a phase drift of the second transceiver 20 with respect to the first transceiver 10 such that the phase difference correction term dPc is defined by

$$d P c = d P 1 + d P 2 + ( dP 2 - dP 3 ) = d P1 + 2 * dP 2 - dP 3 ,$$

which is a corrected final TOA phase difference dPc. The following also applies:
   Offset correction Term: dP2
   Drift correction Term: (dP2-dP3)

In particular, the phase difference correction term dPc is a signal phase dPc.

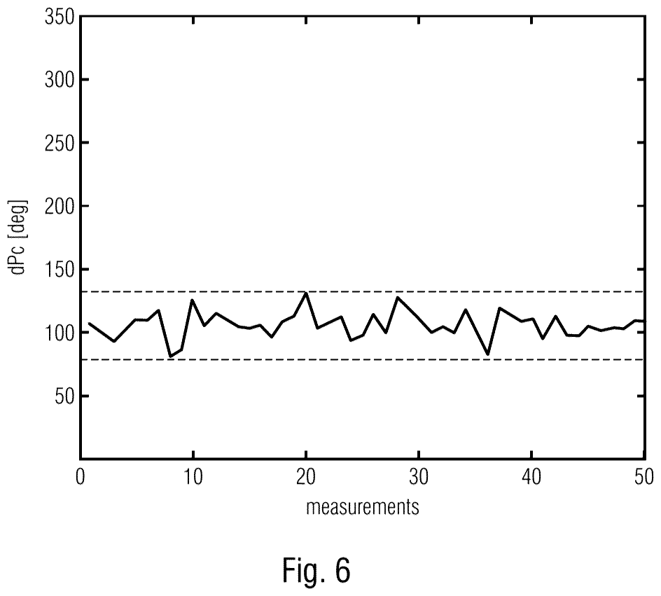

FIG. 6 shows the corrected final TOA phase difference, i.e. the signal phase, dPc. It can be seen that the signal phase is constant at 100 degrees±an error, with the error decreasing with an increasing number of measurements.

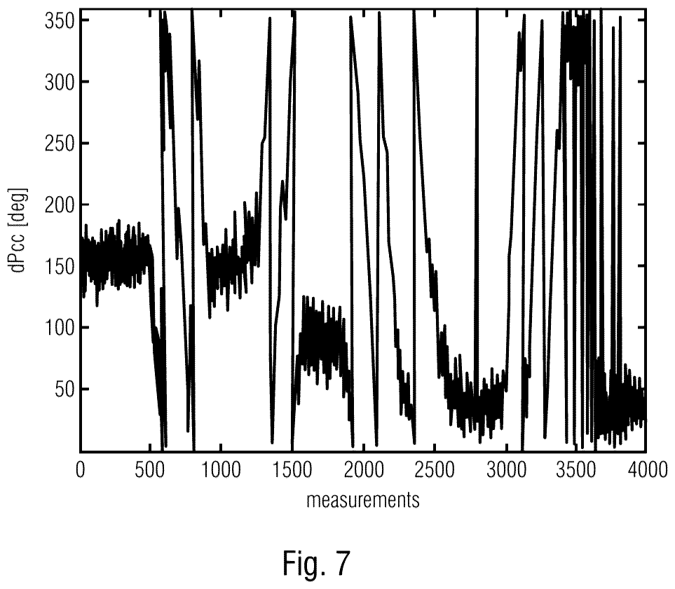

As the distances 25 between the first transceiver 10 and the second transceiver 20 change, the corrected final phase difference, i.e. the signal phase, dPc, also changes, as shown in FIG. 7. The plateaus at 50°, 100° and 150° shown in FIG. 7 (a total of five plateaus can be seen in FIG. 7) each correspond to a specific distance 25 between the first and second transceivers 10, 20. During the measured fluctuations between the plateaus, the first and second transceivers 10, 20 were moved.

The corrected phase difference, i.e. the signal phase, can be converted into a length measure at known wavelengths of the signals 21, 22, 23, 31, 32. Preferably, the phase difference correction method for detecting a change in position of a transceiver 10, 20 detects a changed phase difference and thus a changed signal phase if a measurement rate of received first, second and/or third signals 21, 22, 23 is greater than a ratio of a velocity v to the wavelength of the received first, second and/or third signal 21, 22, 23, wherein the velocity v is a transceiver movement velocity.

Using the phase difference correction method, which may in particular be a TOA pre-correction method, a phase shift of 360 degrees corresponds to only half of the actual wavelength of a signal 21, 22, 23. As can be seen from FIG. 7, it is possible to recognize whether a new period and thus a new phase difference has occurred (=fluctuations between the plateaus indicate a new phase difference) if the measurement rate is sufficiently high. The measurement rate is sufficiently high if plateaus in the corrected final phase difference, i.e. the signal phase dPc, can be measured using the phase difference correction method described herein.

The new period or the new phase difference dPc can be taken into account when the distance 25 is determined. The distance 25 can be determined by adding or subtracting half of the wavelength. Each of the signals 21, 22, 23 has the same wavelength. A phase difference is obtained for each measurement, which can be converted into a distance based on knowing the wavelength. For example, if the transceivers are exactly one wavelength apart, the phase difference would jump back to zero. However, to avoid these, a wavelength is added. With TOA, for example, only half the wavelength is added. If the transceivers were to come closer to each other, the wavelengths would have to be subtracted accordingly.

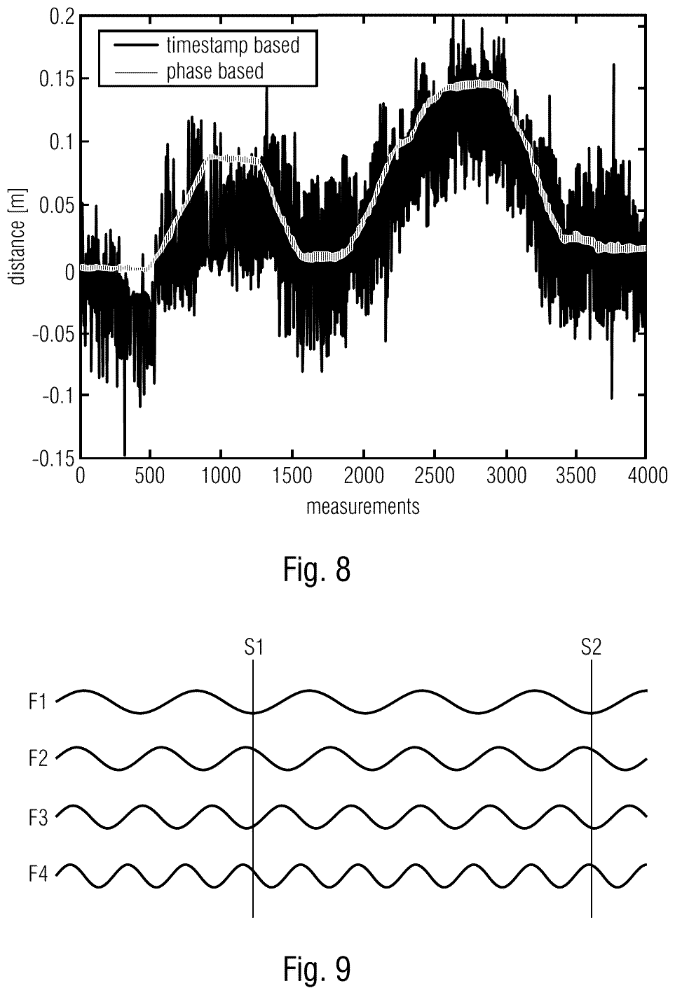

FIG. 8 shows the result of measuring the distance 25 using the classic timestamp-based method and using the phase difference correction method according to the invention. The half wavelength used for the experiments corresponded to 0.0429 meters. It can be clearly seen that the period changes, i.e. the phase differences dPc, can be recognized and that a position accuracy by the phase difference according to the phase difference correction method according to the invention is much higher than with the classic timestamp-based method. The position accuracy with the phase difference correction method according to the invention is increased and at the same time an error in the position accuracy is reduced. The accuracy of the phase-based distance measurement using the phase difference correction method according to the invention is superior to the timestamp method.

However, if the measurement rate is low or the transmission is blocked for a certain period of time, for example by shielding from a wall or a person, it is not possible to follow the correct phase change dPc. This problem can be overcome by updating the phase-based method, i.e. the phase difference correction method, with the timestamp-based method after expiry of a period of time.

Additionally or alternatively, to perform the phase difference correction method, the first and/or second transceivers 10, 20 are configured to transmit the first, second and/or third signals at different frequencies, the phase difference correction method further comprising determining a time window in which all of the different frequencies have a multiple of a period duration, each of the different frequencies having a different multiple of period durations in the time window. As shown in FIG. 9, different transmission frequencies (F1, F2, F3 and F4) are transmitted, for example the following frequencies were used: F1=3494.4 MHZ, F2=3993.6 MHZ, F3=4492.8 MHZ, and F4=6489.6 MHz. In the example shown in FIG. 9, only two solutions S1 and S2 are possible for a specific distance 25. The timestamp-based method can be used to select the correct solution. FIG. 9 shows that the time stamp can reduce the number of possible solutions. Suppose a phase difference of 180° is measured at one frequency and 180° is also measured at another frequency. It is then possible to calculate the exact distances at which this constellation occurs. Suppose this happens at one meter, at two meters and so on. The timestamp method (which is only accurate to within 10 cm) can then be used to decide which of the possible solutions comes into question.

Preferably, the phase difference correction method additionally or alternatively comprises performing a known timestamp-based method, and verifying the phase difference correction method by comparing the results of the known timestamp-based method to the results of the phase difference correction method. For example, a controller can be provided which is configured to execute a comparison program. The uncorrected phase difference is obtained using the same method as described in [2], which has already been explained in the introductory part.

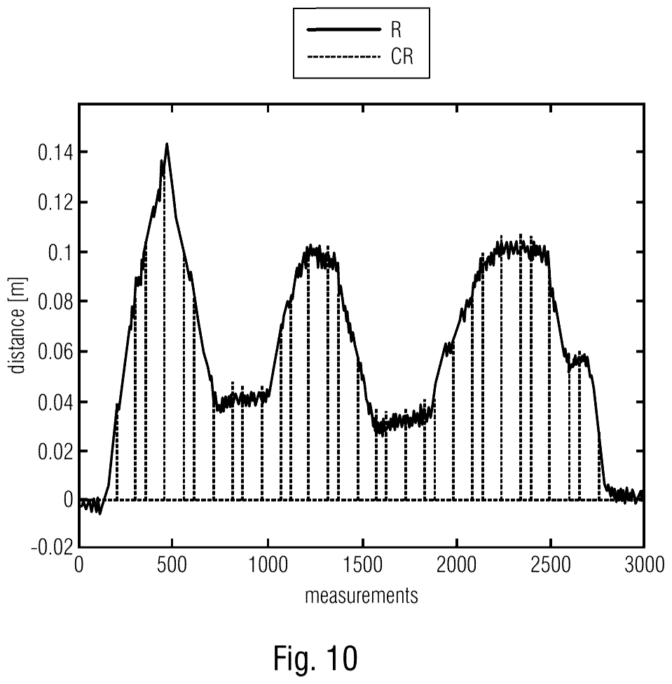

FIG. 10 shows the results of the accuracy correction due to frequency changes. The envelope (R) is the result of the phase difference correction method according to the invention. The columns (CR) in FIG. 10 are the solutions due to the frequency changes. FIG. 10 shows seven plateaus, i.e. at distances 25 of 0 m, 0.04 m and 0.1 m.

The previous section showed how phase difference drift and offset correction can be applied to correct the time of arrival technique.

According to one aspect of the present invention is an ultra-wideband system 100 (see FIG. 3) having a first transceiver 10 and a second transceiver 20 each configured to transmit and receive signals 21, 22, 23 and spaced apart from each other, the system being configured to perform a phase difference correction method as described herein.

The Further Phase Correction Method According to the Invention can be Used in Particular in Connection with the Time Difference of Arrival (TDOA):

The following section shows how the developed correction method can also be used for the arrival time difference. When using the phase correction method in the arrival time difference, the method is referred to as a further phase correction method.

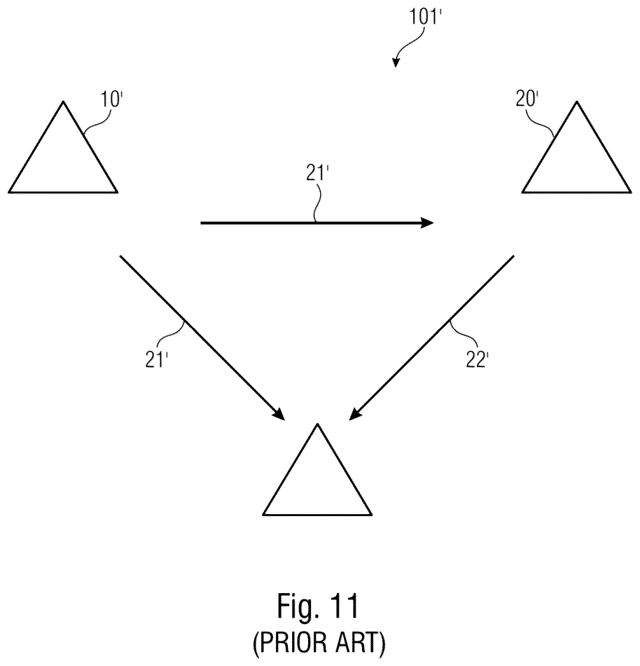

FIG. 11 shows three transceivers 10′, 20′ and 30′ of an ultra-wideband system 101′, which is suitable for executing a method for determining a time difference of arrival (TDOA) and is already known to a person skilled in the art from the known technology. The signals 21′ 22′ are sent between the transceivers 10′, 20′, 30′ with a time stamp.

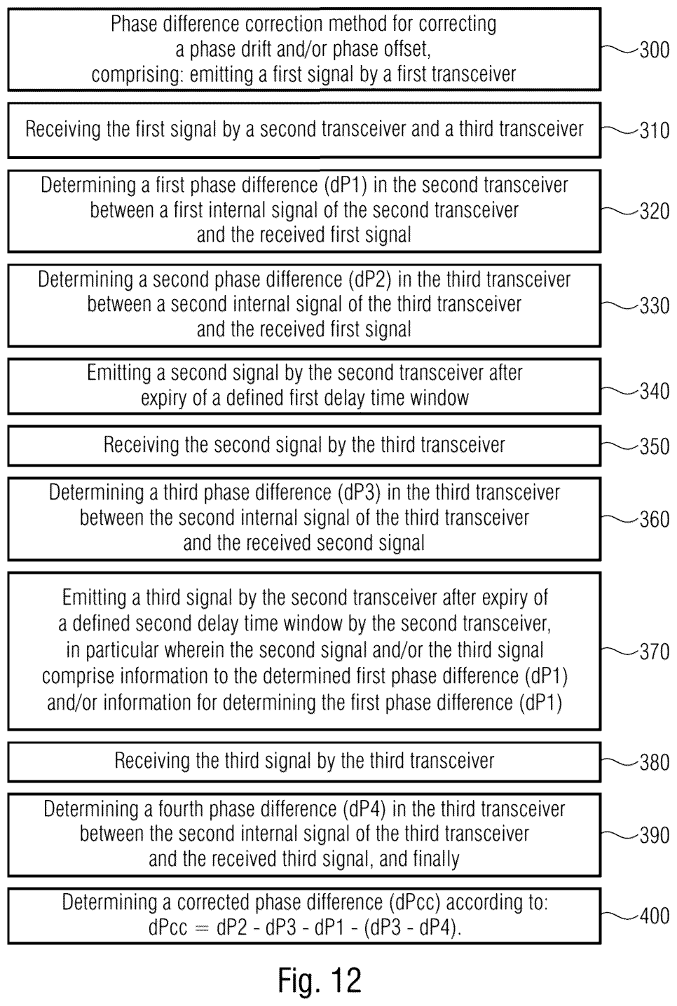

The further phase correction method according to the invention is shown in a flow diagram in FIG. 12 and schematically embedded in an ultra-wideband system 100′ in FIG. 13.

In a first step 300 of the further phase difference correction method for correcting a phase drift and/or phase offset, a first signal 21 is emitted by a first transceiver 10. In step 310, the first signal 21 is received by a second transceiver 20 and a third transceiver 30.

The first, second and third transceivers 10, 20, 30 are each spaced apart by a distance 25, 26. The distance 25 can be different from the distance 26. The first and second transceivers each comprise a transmitter 11 and a receiver 12. As shown in FIG. 13, the third transceiver 30 is implemented as receiver 12, although it is conceivable for the third transceiver 30 to also be implemented with the transmitter 11 and receiver 12. The first, second and third transceivers 10, 20 and 30 each comprise a control device 13 for processing the transmitted and received signals 21, 22 and 23. In particular, the third transceiver 30 may be a passive transceiver, i.e. a receiver. As already mentioned in connection with the phase correction method, it is possible for all phase differences to be calculated in just a single transceiver. It is only important that the measurement values or measurement signals used for this are measured by the receiving transceiver.

After receiving the first signal 22, a first phase difference dP1 in the second transceiver 20 between a first internal signal 31 of the second transceiver 20 and the received first signal 21 is determined in step 320. In addition, a second phase difference dP2 in the third transceiver 30 between a second internal signal 32 of the third transceiver 30 and the received first signal 21 is determined in step 330. Preferably, steps 320 and 330 are performed simultaneously. Steps 320 and 330 may also be one after the other in any order.

The first internal signal 31 can, for example, correspond to the second signal 22, which is also referred to as signal B or B1 in FIG. 13. However, the first internal signal 31 can also be different from the second signal 22, in the sense that the second signal 22 corresponds to the first internal signal 31 plus a drift and/or a different phase.

In step 340, a second signal 22 is emitted by the second transceiver 20 after expiry of a defined first delay time window V1.

In step 350, the second signal 22 is received by the third transceiver 30. After receiving the second signal 22, a third phase difference dP3 is determined in the third transceiver 30 in step 360. The third phase difference dP3 is determined between the second internal signal 32 of the third transceiver 30 and the received second signal 22.

In step 370, a third signal 23 is emitted by the second transceiver 20 after expiry of a defined second delay time window V2 through the second transceiver. In particular, the second signal 22 and/or the third signal 23 comprises/comprise information on the determined first phase difference dP1 or information for determining the first phase difference, as has already been described and to which reference is hereby made.

The first delay time window V1 indicates a period of time from receiving the first signal 21 to emitting the second signal 22. The first delay time window V1 can comprise a time span of a few milliseconds, in particular of less than 1 ms, wherein this depends on the clock used and how strongly the clock drifts. The second transceiver 20 can transmit a response, i.e. the second signal 22, to the third transceiver after a defined delay time V1, the first delay time window V1. The delay time window V1 is seen in relation to the period of time at which the first signal 21 is received.

The second delay time window V2 specifies a period of time from receiving the first signal 21 to emitting the third signal 23. The second delay time window V2 can comprise a period of time of a few nanoseconds, in particular of less than 2 ms. The second transceiver 20 can transmit a response, i.e. the third signal 23 to the third transceiver after a defined delay time V2, the second delay time window V2. The delay time window V2 is seen in relation to the period of time at which the first signal 21 is received.

In step 380, the third signal 23 is received by the third transceiver 30. In step 390, a fourth phase difference dP4 is then determined in the third transceiver 30 between the second internal signal 32 of the third transceiver 30 and the received third signal 23.

Finally, in step 400, a corrected phase difference, i.e. the signal phase dPcc, is determined, in particular by subtracting the determined phase differences dP3, dP4, the third one twice and the fourth one once, from the sum of the determined second phase difference dP2 and the determined fourth phase difference dP4 in accordance with:

$$dPcc = dP 2 - dP 3 - dP 1 - ( dP 3 - dP 4 ) .$$

Here, the offset correction is given by dP1, and the drift correction is given by (dP3−dP4).

According to the further phase correction method, the first transceiver 10 and the second transceiver 20 transmit a signal 21, 22, 23, while the third, in particular passive, transceiver (receiver) 30 only receives the signals 21, 22, 23. The third transceiver determines the second, third and fourth phase differences dP2, dP3, dP4 between the signals 21, 22, 23 of the first and second transceivers 10, 20.

Preferably, the third signal 23 is transmitted at the same time as the second signal 22 or after expiry of the defined second delay time window V2, wherein the second delay time window V2 is greater than the first delay time window.

Preferably, the phase difference correction method comprises determining the second and third phase differences dP2, dP3 by the third transceiver 30 to determine the phase difference (α) between the first signal (21) of the first transceiver (10) and the second signal (22) of the second transceiver (20) from this according to α=dPcc, wherein the phase difference α corresponds to an angle of arrival θ=arcsin (αλ/2πd), where a is the phase difference dPcc, λ is a carrier wavelength of the signals 21, 22, 23, and d is the distance 25 between the first transceiver 10 and the second transceiver 20. In particular, if the distance 25 between the first transceiver 10 and the second transceiver 20 is less than the wavelength A, the signal phase corresponds to the angle of arrival θ=arcsin (αλ/2πd).

The signal exchange between the first transceiver 10 and the second transceiver 20 is used to correct the phase shift between the two transceivers 10, 20. This procedure also takes place in the phase difference correction method described above. The second signal sent by the second transceiver is to correct the phase shift, i.e. the phase drift.

The further phase correction method can be summarized as follows: The first transceiver 10 initializes the process by transmitting the first signal 21. This first signal 21 is received by the second and third transceivers 20, 30. Both transceivers 20, 30 then determine the phase difference between the received first signal 21 and an internal signal (dP1 and dP2). The second transceiver 20 reacts to the first signal 21 by transmitting the second and third signals 22, 23, which are also referred to as signals B1 and B2 in FIG. 13, after the delay time window V1 and the delay time window V2. The phase difference dP1 is used to correct the phase offset between the first transceiver 10 and the second transceiver 20, while the second and third signals 22, 23 or signal B1 and signal B2, respectively, are used to correct the phase drift. The third transmitter 30 receives the first signal 21, the second and the third signal 22, 23 and determines the phase differences dP2 and dP3. The phase difference dP4 corresponds to the phase difference between the third signal 23 or signal B2 and the second internal signal 32. The final corrected phase difference, i.e. the signal phase, for TDOA equals:

$$dPcc = dP 2 - dP 3 - dP 1 - ( dP 3 - dP 4 ) .$$

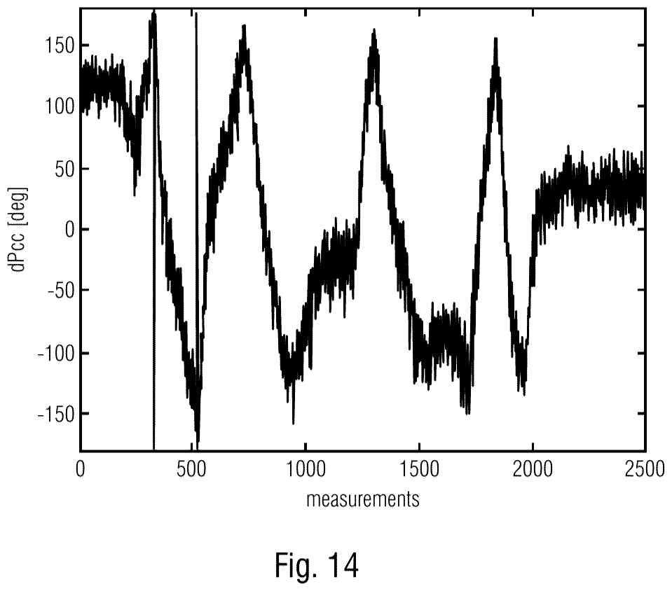

FIG. 14 shows the final corrected phase difference, i.e., the signal phase dPcc, which has been obtained by applying the further phase difference correction method for TDOA. FIG. 14 shows the corrected phase difference, i.e. the signal phase dPcc, when the position of the third transceiver 30 is changed with real measurement data, such as a distance change by around 30 cm. The signal phase is in the range of −180 to 180 degrees, which corresponds, for example, to a single period of a wavelength with a frequency of 6489.6 MHz.

Another aspect of the present invention relates to an ultra-wideband system 101 comprising a first transceiver 10 and a second transceiver 20 and a third transceiver 30, wherein the transceivers 10, 20, 30 are each spaced apart by a distance, wherein the ultra-wideband system 101 is configured to perform the further phase difference correction method as just described.

Another aspect of the present invention relates to a computer program code which performs steps of a phase difference correction method or a further phase difference correction method as described herein when the computer program code is executed on a program code executable medium. For example, the first to third transceivers 10, 20, 30 are media capable of executing the program code.

Individual aspects of the phase difference correction method described herein also apply to the further phase difference correction method described and vice versa, without necessarily being repeated in detail.

One difference between the described phase difference correction method and the further described phase difference correction method is that the described phase difference correction method comprises two transceivers (see FIG. 3) and the further described phase difference correction method comprises three transceivers (see FIG. 13).

Common to the described phase difference correction method and the further described phase difference correction method is that phase differences between at least one received signal and an internal signal as well as a phase difference between two received signals are determined to achieve the phase difference drift and offset correction between the signals.

The following can be achieved with the phase difference correction methods described herein:
UWB phase drift correction by an additional signal.
UWB phase offset correction between two or more transceivers.
UWB phase difference correction term for TOA and TDOA.
UWB frequency change to correct the distance obtained by the corrected phase difference corresponding to the signal phase.

Although some aspects have been described in the context of an apparatus or arrangement, it is clear that these aspects also constitute a description of the corresponding method, wherein a block or apparatus corresponds to a method step or a feature of a method step. In analogy, aspects described in the context of a method step also constitute a description of a corresponding block or element or feature of a corresponding apparatus.

The inventive methods may be stored on a digital storage medium or transmitted on a transmission medium such as a wireless transmission medium or a wired transmission medium such as the Internet.

Depending on certain implementation requirements, embodiments of the invention can be implemented in hardware or in software. The implementation may be with a digital storage medium, such as a floppy disk, a DVD, CD, ROM, PROM, EPROM, EEPROM or FLASH memory, on which electronically readable control signals are stored, which cooperate or are able to cooperate with a programmable computer system such that the respective method is carried out.

Some embodiments according to the invention comprise a data carrier with electronically readable control signals which (can) cooperate with a programmable computer system in such a way that one of the methods described herein is carried out. In particular, the electronically readable control signals are configured to detect timestamps of a signal.

In general, embodiments of the present invention may be implemented as a computer program product comprising program code, wherein the program code is effective to perform any of the methods when the computer program product runs on a computer. For example, the program code may be stored on a machine-readable medium.

Other embodiments comprise the computer program stored on a machine-readable carrier for performing any of the methods described herein.

In other words, an embodiment of the inventive method is therefore a computer program comprising program code for performing any of the methods described herein when the computer program runs on a computer.

Thus, another embodiment of the inventive method is a data carrier (or a digital storage medium or a computer-readable medium) containing and recorded on the computer program for performing any of the methods described herein.

Thus, another embodiment of the inventive method is a data stream or sequence of signals representing the computer program for performing any of the methods described herein. The data stream or sequence of signals may, for example, be configured to be transmitted via a data communication link, for example over the Internet.

Another embodiment comprises processing means, such as a computer or programmable logic device, configured or adapted to perform any of the methods described herein.

Another embodiment comprises a computer on which the computer program for performing any of the methods described herein is installed.

In some embodiments, a programmable logic device (e.g., a field-programmable gate array) may be used to perform some or all of the functionalities of the methods described herein. In some embodiments, a field-programmable gate array may cooperate with a microprocessor to perform any of the methods described herein. In general, the methods may be performed by any hardware device.

While this invention has been described in terms of several embodiments, there are alterations, permutations, and equivalents which fall within the scope of this invention. It should also be noted that there are many alternative ways of implementing the methods and compositions of the present invention. It is therefore intended that the following appended claims be interpreted as including all such alterations, permutations and equivalents as fall within the true spirit and scope of the present invention.

### BIBLIOGRAPHY

[1] https://patents.justia.com/patent/20200045661
[2] https://patents.justia.com/patent/10509116
[3] https://patents.justia.com/patent/10992340
[4] J. Sidorenko, V. Schatz, N. Scherer-Negenborn, M. Arens and U. Hugentobler, “Error Corrections for Ultrawideband Ranging,” in IEEE Transactions on Instrumentation and Measurement, vol. 69, no. 11, pp. 9037-947 Nov. 2020, doi: 10.1109/TIM.2020.2996706.
[5] https://patentscope.wipo.int/search/en/detail.jsf?docld=WO2020165429
[6] J. Sidorenko, V. Schatz, N. Scherer-Negenborn, M. Arens and U. Hugentobler, “DecaWave Ultra-Wideband Warm-Up Error Correction,” in IEEE Transactions on Aerospace and Electronic Systems, vol. 57, no. 1, pp. 751-760, February 2021, doi: 10.1109/TAES.2020.3015323.

1. A phase difference correction method for correcting a phase drift and/or phase offset, comprising:
emitting a first signal by a first transceiver,
receiving the first signal by a second transceiver,
determining a first phase difference in the second transceiver between a first internal signal of the second transceiver and the received first signal,
emitting a second signal by the second transceiver after expiry of a defined first delay time window, the second signal comprising information on the determined first phase difference and/or information for determining the first phase difference,
receiving the second signal by the first transceiver,
determining a second phase difference in the first transceiver between a second internal signal of the first transceiver and the received second signal, and
summing the first determined phase difference and the second determined phase difference, wherein a phase offset between the two transceivers is corrected by this.

2. The phase difference correction method according to claim 1, further comprising:
emitting a third signal by the second transceiver after expiry of a defined second delay time window, wherein in particular the third signal comprises information on the second signal;
receiving the third signal by the first transceiver;
determining a third phase difference between the third signal received by the first transceiver and the second internal signal in the first transceiver,
wherein the third phase difference determines a phase drift of the second transceiver with respect to the first transceiver so that a phase difference correction term dPc is determined by
$$d P c = d P 1 + d P 2 + ( dP 2 - dP 3 ) ,$$
where in particular the phase difference correction term dPc is a signal phase dPc.

3. The phase difference correction method according to claim 1, wherein the first delay time window corresponds to a time interval between receiving the first signal by the second transceiver and emitting the second signal by the second transceiver.

4. The phase difference correction method according to claim 1, wherein the second delay time window corresponds to a time interval between receiving the first signal by the second transceiver and emitting the third signal by the second transceiver.

5. The phase difference correction method according to claim 2, wherein V2=2*V1 applies to the second delay time window V2.

6. The phase difference correction method according to claim 1, wherein a changed phase difference is detected for detecting a position change of a transceiver when a measurement rate of received first, second and/or third signals is greater than a ratio of a velocity to the wavelength of the received first, second and/or third signal, wherein the velocity is a transceiver movement velocity.

7. The phase difference correction method according to claim 1, wherein the first and/or second transceiver is/are configured to transmit the first, second and/or third signal at different frequencies, the phase difference correction method further comprising:
determining a time window in which all of the different frequencies comprise a multiple of a period duration, each of the different frequencies comprising a different multiple of period durations in the time window.

8. The phase difference correction method according to claim 1, additionally comprising:
performing a known timestamp-based method, and
verifying the phase difference correction method by comparing the results of the known timestamp-based method to the results of the phase difference correction method.

9. An ultra-wideband system comprising:
a first transceiver and a second transceiver each configured to transmit and receive signals and spaced apart from each other, the system being configured to perform a phase difference correction method according to claim 1.

10. A phase difference correction method for correcting a phase drift and/or phase offset, comprising:
emitting a first signal by a first transceiver,
receiving the first signal by a second transceiver and a third transceiver,
determining a first phase difference in the second transceiver between a first internal signal of the second transceiver and the received first signal,
determining a second phase difference in the third transceiver between a second internal signal of the third transceiver and the received first signal,
emitting a second signal by the second transceiver after expiry of a defined first delay time window,
receiving the second signal by the third transceiver,
determining a third phase difference in the third transceiver between the second internal signal of the third transceiver and the received second signal,
emitting a third signal by the second transceiver after expiry of a defined second delay time window by the second transceiver, in particular wherein the second signal and/or the third signal comprise information to the determined first phase difference and/or information for determining the first phase difference;
receiving the third signal by the third transceiver;
determining a fourth phase difference in the third transceiver between the second internal signal of the third transceiver and the received third signal, and finally
determining a corrected phase difference according to:
$$dPcc = dP 2 - dP 3 - dP 1 - ( dP 3 - dP 4 ) .$$

11. The phase difference correction method according to claim 10, wherein the third signal is transmitted at the same time as the second signal or after expiry of the defined second delay time window, the second delay time window being greater than the first delay time window.

12. The phase difference correction method according to claim 10, further comprising:
determining the second and third phase differences by the third transceiver in order to determine therefrom the phase difference between the first signal of the first transceiver and the second signal of the second transceiver according to α=dPcc, wherein the phase difference α corresponds to an angle of arrival θ=arcsin (αλ/2πd), where α is the phase difference, λ is the carrier wavelength, and d is the distance between the first transceiver and the second transceiver.

13. An ultra-wideband system comprising:
a first transceiver and a second transceiver and a third transceiver spaced apart from one another by a distance, the system being configured to perform a phase difference correction method according to claim 10.

14. A non-transitory digital storage medium having stored thereon a computer program for performing the phase difference correction method according to claim 1, when the computer program code is run by a computer.
